(19) United States
(12) Patent Application Publication
(10) Pub. No.: US 2019/0164702 A1
(43) Pub. Date: May 30, 2019

(54) KEY APPARATUS

(71) Applicant: Chicony Electronics Co., Ltd., New Taipei City (TW)

(72) Inventors: Kuang-Shen Uang, New Taipei City (TW); Chia-Wei Chang, New Taipei City (TW)

(21) Appl. No.: 15/883,854

(22) Filed: Jan. 30, 2018

(30) Foreign Application Priority Data
Nov. 24, 2017 (TW) 106141058

(51) Int. Cl. H01H 13/705; H01H 13/18

(52) U.S. Cl. CPC H01H 13/705; H01H 13/186

(57) ABSTRACT

A key apparatus includes a substrate, a keycap, a balancing lever, and a membrane layer. The keycap is disposed on the substrate. The balancing lever is disposed between the substrate and the keycap. The balancing lever includes a shaft lever and a side lever extending from a side direction of the shaft lever. The side lever has an end away from the shaft lever. The membrane layer is disposed on the substrate. The membrane layer is provided with a cutting structure. The cutting structure is close to the end of the side lever. The membrane layer further includes a flexible limiting area located on one side of the cutting structure. The side lever of the balancing lever is inserted in the cutting structure, and makes the end be held against the flexible limiting area.

### CROSS-REFERENCE TO RELATED APPLICATION

This non-provisional application claims priority under 35 U.S.C. § 119(a) to Patent Application No. 106141058 filed in Taiwan, R.O.C. on Nov. 24, 2017, the entire contents of which are hereby incorporated by reference.

### BACKGROUND

### Technical Field

The present invention relates to a keyboard assembly, and in particular, to a key apparatus.

### Related Art

At present, a keyboard is a very common input device and is generally used with an electronic apparatus such as a desktop computer, a notebook computer, a smartphone or a tablet computer. At present, in order to enable a key of a keyboard to transfer strength more uniformly after being pressed, a balancing lever is generally installed inside the key, so that pressing strength is transferred to corners by using the balancing lever to enable the key to descend uniformly.

A key structure of a conventional keyboard mainly includes a metal substrate, a keycap, and a balancing lever. The balancing lever is assembled between the keycap and the metal substrate. A manner of assembling the balancing lever and the metal substrate is generally that a fixed plate extends upward from the metal substrate, and the fixed plate is provided with a sliding groove. Ends of the balancing lever are inserted in the sliding groove of the fixed plate to be combined with the fixed plate. However, in this manner, in a process of operating a key, the balancing lever and the metal substrate tend to strike each other, causing noise during use of the keyboard.

### SUMMARY

In view of this, in an embodiment, a key apparatus is provided, including: a substrate, a keycap, a balancing lever, and a membrane layer. The keycap is disposed on the substrate. The balancing lever is disposed between the substrate and the keycap. The balancing lever includes a shaft lever and a side lever extending from a side direction of the shaft lever. The side lever has an end away from the shaft lever. The membrane layer is disposed on the substrate. The membrane layer is provided with a cutting structure. The cutting structure is close to the end of the side lever. The membrane layer further includes a flexible limiting area located on one side of the cutting structure. The side lever of the balancing lever is inserted in the cutting structure, and makes the end be held against the flexible limiting area.

In conclusion, in the key apparatus of the embodiment of the present invention, a membrane layer is disposed on a substrate, and a cutting structure is provided at a position, close to an end of a side lever of a balancing lever, of the membrane layer, so that one side of the cutting structure forms a flexible limiting area, for the side lever of the balancing lever to be inserted in the cutting structure, and to make the end of the side lever be held against the flexible limiting area to be limited. In this way, in the present invention, the side lever of the balancing lever is limited by using the membrane layer, the balancing lever and the substrate can be prevented from rubbing or striking each other during the operation of the key apparatus, and an advantage of effectively reducing noise can be achieved.

### BRIEF DESCRIPTION OF THE DRAWINGS

FIG. 1 is a three-dimensional exploded view of a first embodiment of a key apparatus according to the present invention;

FIG. 2 is another three-dimensional exploded view of the first embodiment of the key apparatus according to the present invention;

FIG. 3 is a partial top view of the first embodiment of the key apparatus according to the present invention;

FIG. 4 is a sectional view along 4-4 in FIG. 3;

FIG. 5 is a sectional view along 5-5 in FIG. 3;

FIG. 6 is a partial three-dimensional exploded view of a second embodiment of a key apparatus according to the present invention;

FIG. 7 is a partial three-dimensional exploded view of a third embodiment of a key apparatus according to the present invention;

FIG. 8 is a partial sectional view of a fourth embodiment of a key apparatus according to the present invention; and

FIG. 9 is a partial sectional view of a fifth embodiment of a key apparatus according to the present invention.

### DETAILED DESCRIPTION

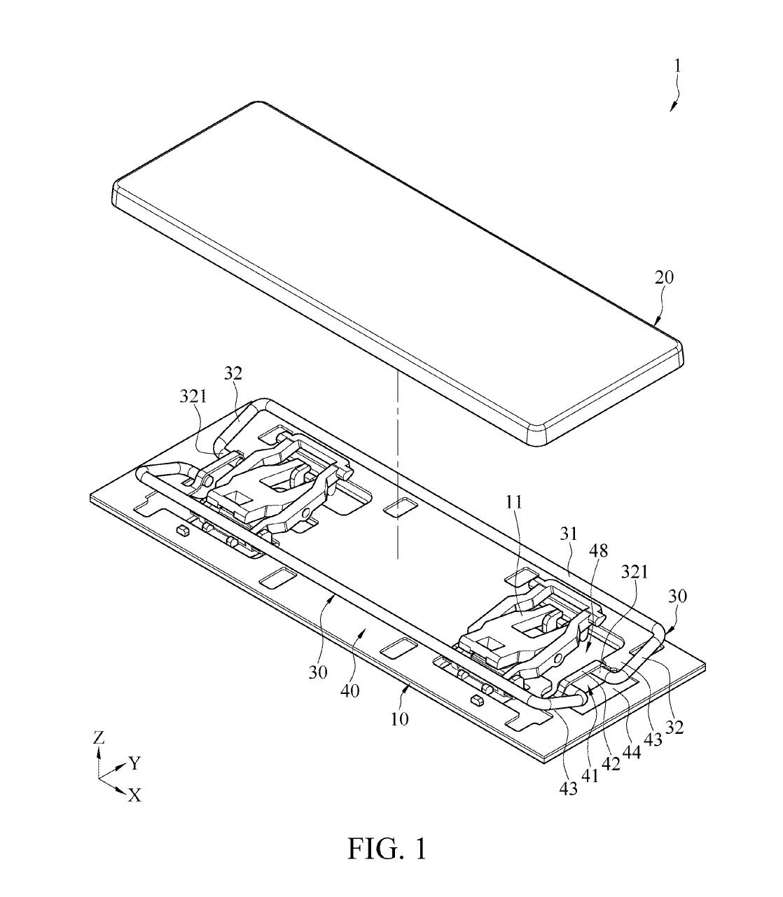

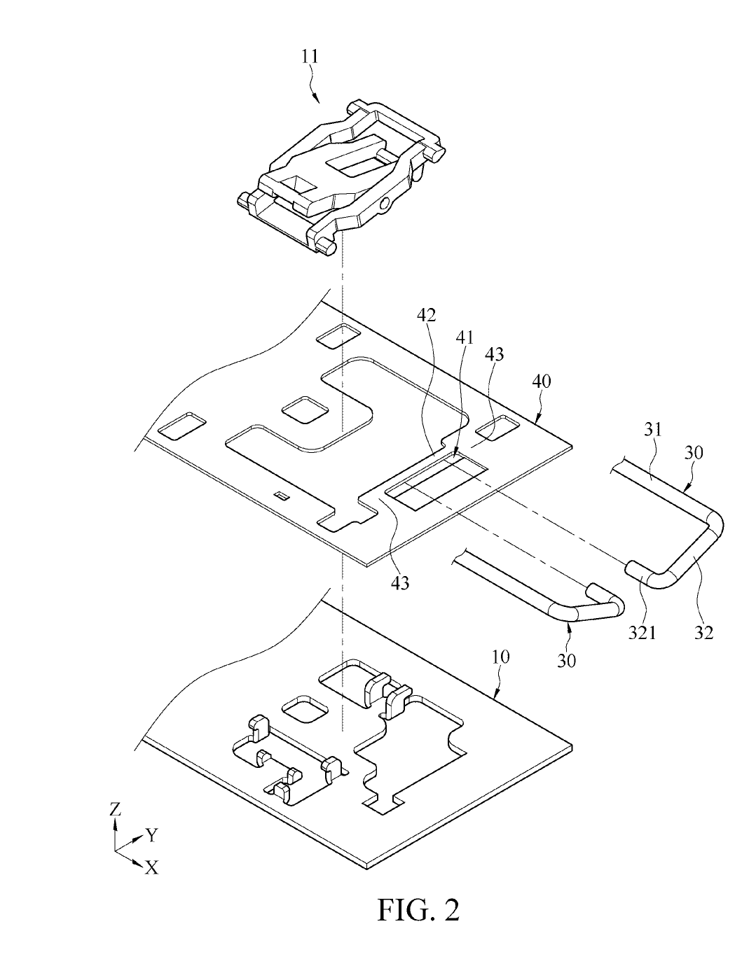

FIG. 1 is a three-dimensional exploded view of a first embodiment of a key apparatus according to the present invention. FIG. 2 is another three-dimensional exploded view of the first embodiment of the key apparatus according to the present invention. As shown in FIG. 1 and FIG. 2, in this embodiment, a key apparatus 1 includes a substrate 10, a keycap 20, a balancing lever 30, and a membrane layer 40. The keycap 20 is disposed on the substrate 10. The balancing lever 30 is disposed between the substrate 10 and the keycap 20. The membrane layer 40 is disposed on the substrate 10.

In an embodiment, the substrate 10 may be preferably a metal plate body. For example, the substrate 10 is made of a material such as iron, aluminum, or another alloy, and has desirable structural strength, but this is not limited. The substrate 10 may alternatively be made of another rigid material.

As shown in FIG. 1 and FIG. 2, the keycap 20 may be connected on the substrate 10 through a linkage member 11. For example, in this embodiment, the linkage member 11 is a scissors structure and is connected between the keycap 20 and the substrate 10. When the keycap 20 is pressed by a user, the linkage member 11 rotates and retracts relatively, so as to guide the keycap 20 to shift to the substrate 10. In contrast, when the keycap 20 is not pressed, by means of elastic resetting of an elastic member (not shown in the figure), the linkage member 11 can rotate and retract relatively, so as to guide the keycap 20 to shift away from the substrate 10. However, the foregoing embodiment is merely an example. In fact, the elastic member may alternatively have another implementation form, for example, a mechanical switch or a metal spring.

In an embodiment, the key apparatus 1 may be provided with one or more balancing levers 30. For example, in the embodiment of FIG. 1 and FIG. 2, the key apparatus 1 is provided with two balancing levers 30. Each balancing lever 30 includes a shaft lever 31 and two side levers 32. The two side levers 32 are separately connected to two ends of the shaft lever 31, and each side lever 32 extends from a side direction of the shaft lever 31 and has an end 321 away from the shaft lever 31. Herein, each side lever 32 is formed by integrally bending the ends of the shaft lever 31, and an included angle between each side lever 32 and the shaft lever 31 is about 90°, but this is not limited. The included angle between each side lever 32 and the shaft lever 31 may alternatively be an obtuse angle or an acute angle. In addition, each balancing lever 30 may be preferably a metal lever. For example, each balancing lever 30 is made of a material such as iron, aluminum, or another alloy, and has desirable structural strength, but this is not limited. Each balancing lever 30 may alternatively be made of another rigid material.

For another example, as shown in FIG. 1 and FIG. 2, the shaft lever 31 of each balancing lever 30 may be pivoted at a bottom of the keycap 20. For example, the bottom of the keycap 20 may be provided with a plurality of axial holes (not shown in the figure), for the shaft lever 31 of each balancing lever 30 to be pivoted, so that the shaft lever 31 can rotate relative to the keycap 20.

In an embodiment, the membrane layer 40 may be specifically a flexible membrane layer. For example, a material of the membrane layer 40 may be polyimide, polyethylene terephthalate or polycarbonate and has flexibility. As shown in FIG. 1 and FIG. 2, the membrane layer 40 is provided with a cutting structure 41. The cutting structure 41 is close to the end 321 of the side lever 32. The membrane layer 40 further includes a flexible limiting area 42 located on one side of the cutting structure 41, that is, the flexible limiting area 42 is a partial area of the membrane layer 40 and is formed on one side of the cutting structure 41. The side lever 32 of each balancing lever 30 is inserted in the cutting structure 41, and the end 321 of the side lever 32 is held against the flexible limiting area 42 to be limited. In this way, in the embodiment of the present invention, the side lever 32 of the balancing lever 30 is limited by using the membrane layer 40, the balancing lever 30 and the substrate 10 can be prevented from rubbing or striking each other during the operation of the key apparatus 1, and an advantage of effectively reducing noise can be achieved.

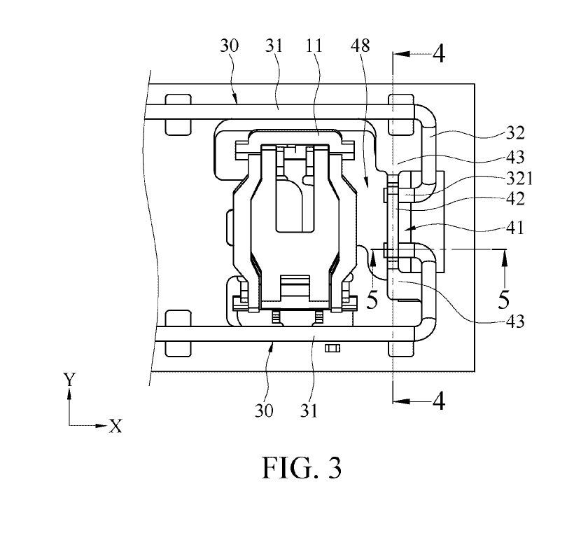

For example, in the embodiment of FIG. 1, FIG. 2, and FIG. 3, the membrane layer 40 is provided with a through hole 48 corresponding to the linkage member 11. The cutting structure 41 is provided at a position close to the through hole 48. The flexible limiting area 42 is a flexible long strip formed between the through hole 48 and the cutting structure 41. In addition, in this embodiment, the shaft lever 31 of the balancing lever 30 extends along the X axis, and the side lever 32 of the balancing lever 30 extends along the Y axis. The end 321 is a hook formed by integrally bending the side lever 32. The flexible limiting area 42 extends along the Y axis, and the end 321 of the side lever 32 may be inserted in the cutting structure 41 along the X axis. Because the flexible limiting area 42 has flexibility, the flexible limiting area 42 may deform flexibly towards the keycap 20 during insertion of the end 321, to further make the flexible limiting area 42 be held against the end 321, so that the end 321 can be hooked in the flexible limiting area 42 to be limited and a distance can be kept between the end 321 and the substrate 10.

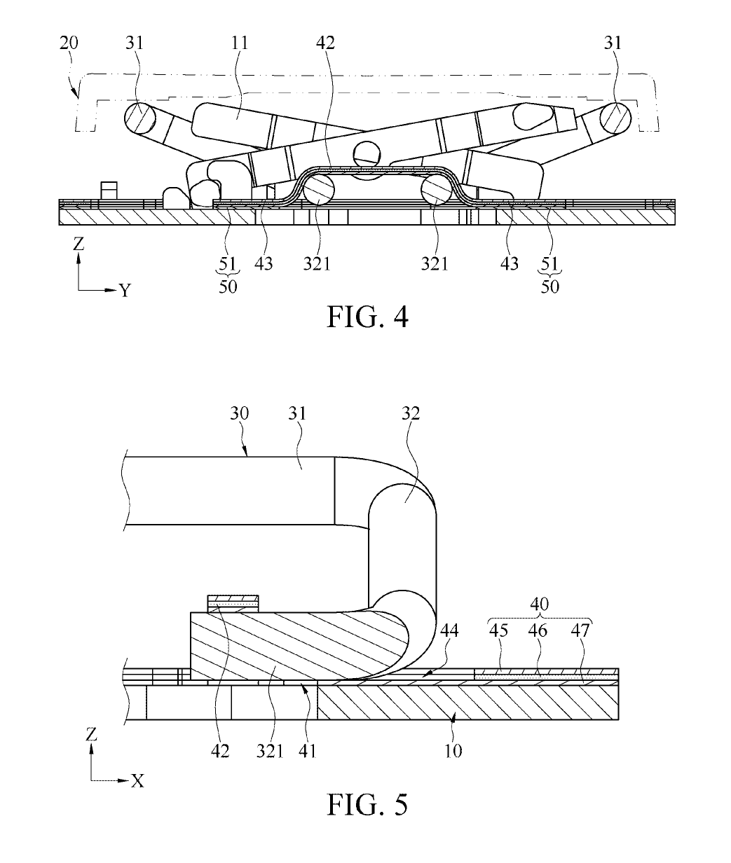

In this way, as shown in FIG. 4, when the keycap 20 is operated by a user, the shaft lever 31 of each balancing lever 30 can rotate relative to the keycap 20 and guide the keycap 20 to move up and down. The end 321 of the side lever 32 slides along the Y axis, and continues to be held and limited by the flexible limiting area 42. In addition, because the end 321 of the side lever 32 is hooked in the flexible limiting area 42 and a distance is kept between the end 321 and the substrate 10, the balancing lever 30 is not in contact with the substrate 10 during movement, so that noise can be avoided.

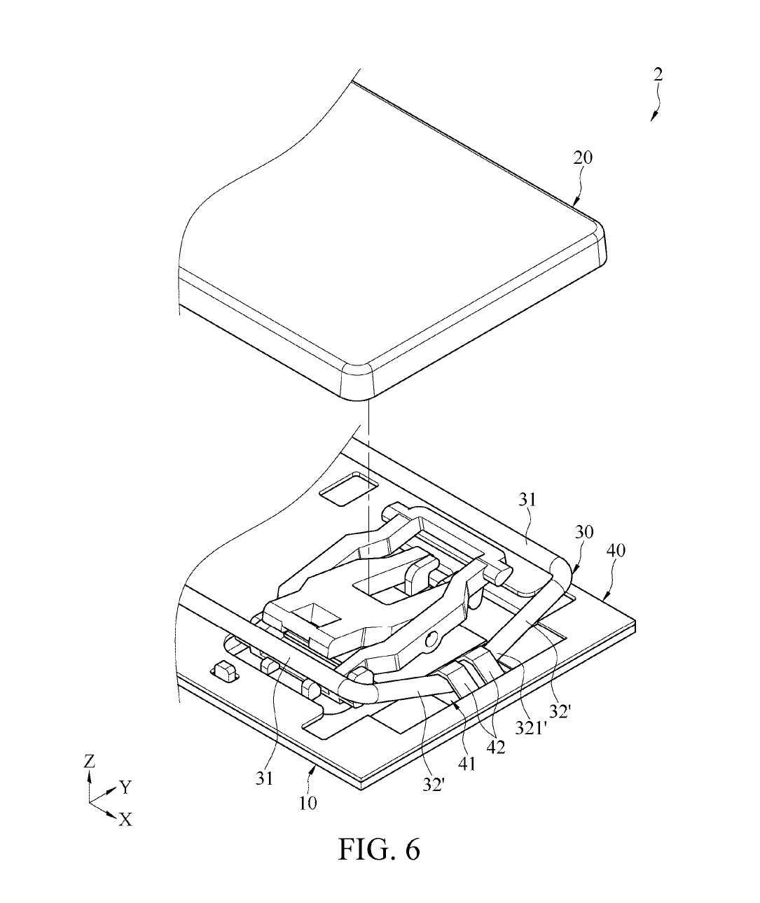

However, the foregoing embodiments are merely examples. In fact, the position of the cutting structure 41 and the extending direction of the flexible limiting area 42 may be different depending on the position and shape of the balancing lever 30. For example, FIG. 6 is a partial three-dimensional exploded view of a second embodiment of a key apparatus according to the present invention. A side lever 32′ of the balancing lever 30 of a key apparatus 2 of this embodiment has a straight bar shape (extending along the Y axis herein), and the flexible limiting area 42 of this embodiment is perpendicular to the side lever 32′ (extending along the X axis herein), so that the side lever 32′ can be inserted in the cutting structure 41 and make an end 321′ of the side lever 32′ be held against the flexible limiting area 42.

In an embodiment, the membrane layer 40 may be a membrane circuit board. When a user presses the keycap 20, the membrane circuit board may be triggered correspondingly, to generate a corresponding signal. As shown in FIG. 5, in this embodiment, the membrane layer 40 includes an upper membrane layer 45, a spacer layer 46, and a lower membrane layer 47. The spacer layer 46 is sandwiched between the upper membrane layer 45 and the lower membrane layer 47. The lower membrane layer 47 is farther away from the keycap 20 than the upper membrane layer 45 is. The cutting structure 41 at least penetrates the upper membrane layer 45. For example, in the embodiment of FIG. 5, a partial cutting structure 41 is a three-layer membrane structure that penetrates the upper membrane layer 45, the spacer layer 46, and the lower membrane layer 47, and forms the flexible limiting area 42. The end 321 of the side lever 32 of each balancing lever 30 may be held below at least one layer of the flexible limiting area 42 according to a requirement. However, in another embodiment, the cutting structure 41 may penetrate only the upper membrane layer 45, or the cutting structure 41 may penetrate only the upper membrane layer 45 and the spacer layer 46, but this is not limited. In this way, the membrane layer 40 of this embodiment may have both functions of generating a trigger signal and limiting the side lever 32 of each balancing lever 30, to further achieve the advantage of reducing costs.

As shown in FIG. 1, the membrane layer 40 may include a bearing area 44. The bearing area 44 and the flexible limiting area 42 may be separately located on two opposite sides of the cutting structure 41. A bottom of the side lever 32 is further held against the bearing area 44. For example, in the embodiment of FIG. 5, a partial area, away from the flexible limiting area 42, of the cutting structure 41 penetrates only the upper membrane layer 45 and the spacer layer 46, and the bottom of the end 321 of the side lever 32 may be borne on a partial lower membrane layer 47 that is not penetrated by the cutting structure 41, to further reduce a possibility that the end 321 of the side lever 32 comes into contact with the substrate 10 during the operation of the key apparatus 1. It should be particularly noted that, the cutting structure 41 may alternatively penetrate only the upper membrane layer 45, and the bottom of the end 321 of the side lever 32 may be borne on a partial spacer layer 46 that is not penetrated by the cutting structure 41. This is not limited in the present invention.

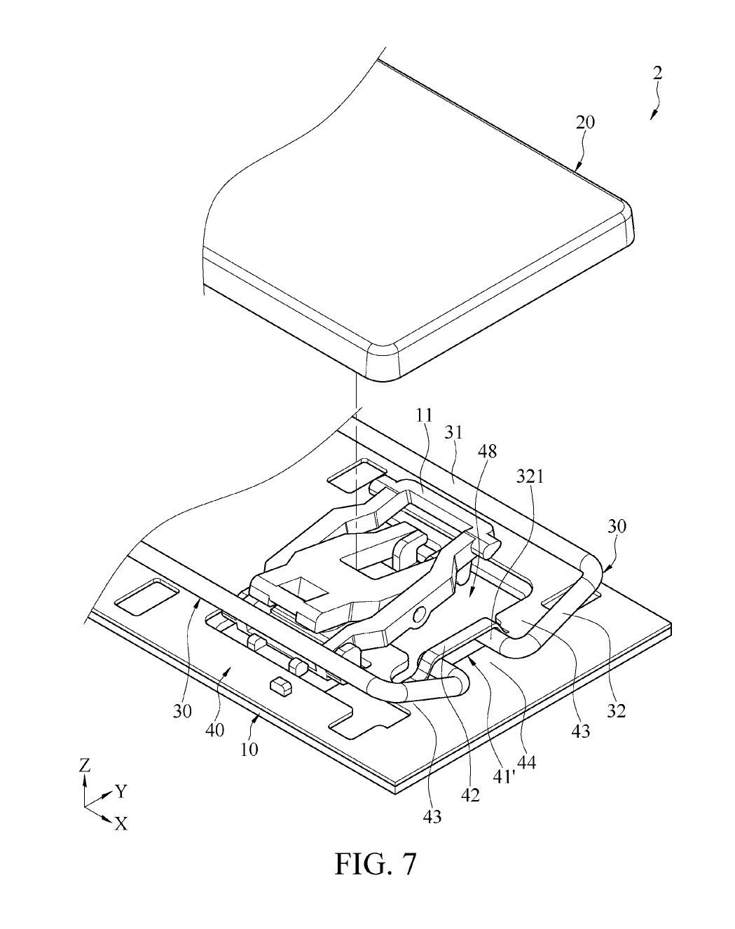

As shown in FIG. 1 and FIG. 2, the cutting structure 41 of the membrane layer 40 may be a slot with a particular area. For example, in this embodiment, the cutting structure 41 is a rectangular slot, but this is not limited. The cutting structure 41 may alternatively be circular, elliptic, trapezoidal, or another irregularly shaped slot. Alternatively, FIG. 7 is a partial three-dimensional exploded view of a third embodiment of a key apparatus according to the present invention. A difference of this embodiment from the embodiment of FIG. 1 lies in the shape of the cutting structure. A cutting structure 41′ of the membrane layer 40 of this embodiment is a kerf, which may be used to further lower the difficulty of processing and reduce generation of waste materials.

As shown in FIG. 4, in an embodiment, the membrane layer 40 includes two holding areas 43 that are separately adjacent to two ends of the flexible limiting area 42, the key apparatus 1 further includes a fixing member 50 to fix the two holding areas 43 correspondingly, to prevent the flexible limiting area 42 from shifting under a force during the movement of the balancing lever 30, so that the assembly state of the balancing lever 30 and the flexible limiting area 42 is more stable. For example, in this embodiment, the fixing member 50 includes an adhesive layer 51, and the adhesive layer 51 is adhered between each holding area 43 and the substrate 10, so that each holding area 43 is fixed on the substrate 10.

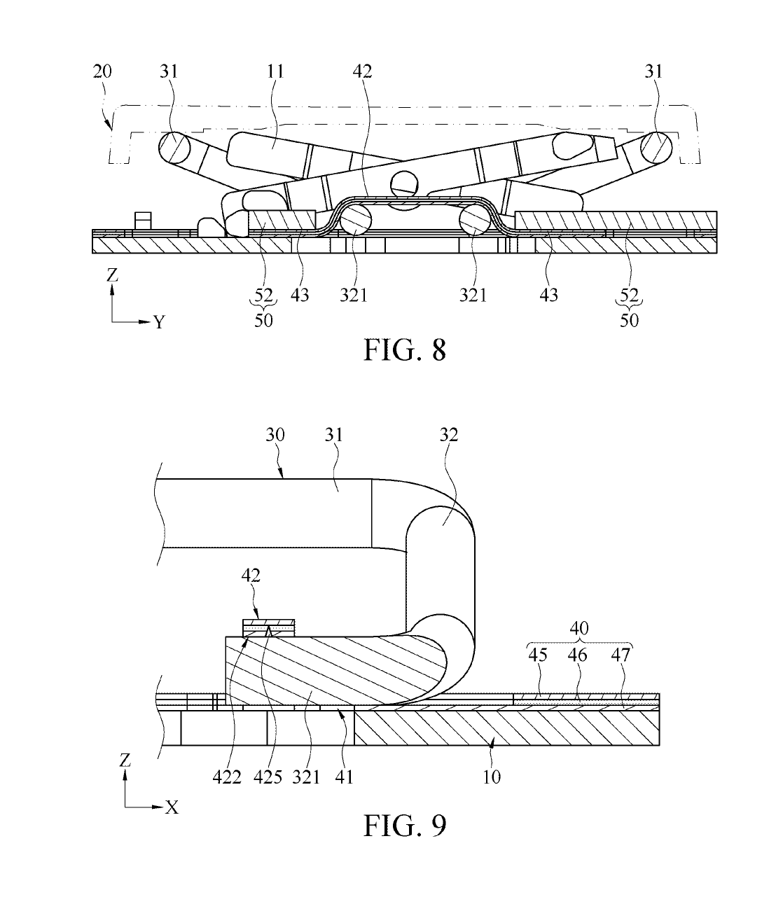

In another embodiment, as shown in FIG. 8, the fixing member 50 may alternatively be fixed on the membrane layer 40 and held against the two holding areas 43 to locate the holding areas 43. For example, in the embodiment of FIG. 8, the fixing member 50 may include a cover plate 52. The cover plate 52 covers the membrane layer 40 is and held against the two holding areas 43, but this is not limited. In another embodiment, the fixing member 50 may alternatively be a pressing block or a protruding rib that extends from another component (for example, the substrate 10, the linkage member 11, or the keycap 20) of the key apparatus 1 to be held against the two holding areas 43. Referring to FIG. 4 and FIG. 8 by comparison, in some embodiments, the fixing member 50 may alternatively include both an adhesive layer 51 and a cover plate 52, to further enhance a locating effect of the holding areas 43.

In an embodiment, a lower surface 422 of the flexible limiting area 42 of the membrane layer 40 is held against the side lever 32, and the lower surface 422 is provided with an anti-slip structure 425, to prevent the balancing lever 30 from shaking during movement to achieve higher stability. For example, in the embodiment of FIG. 9, the anti-slip structure 425 is a cutting groove disposed on the lower surface 422, but this is not limited. In another embodiment, the anti-slip structure 425 may alternatively be raised lines, holes, or anti-slip pads (these are omitted in the figures of the embodiment) disposed on the lower surface 422.

In conclusion, in the key apparatus of the embodiment of the present invention, a membrane layer is disposed on a substrate, and a cutting structure is provided at a position, close to an end of a side lever of a balancing lever, of the membrane layer, so that one side of the cutting structure forms a flexible limiting area, for the side lever of the balancing lever to be inserted in the cutting structure, and to make the end of the side lever be held against the flexible limiting area to be limited. In this way, in the present invention, the side lever of the balancing lever is limited by using the membrane layer, the balancing lever and the substrate can be prevented from rubbing or striking each other during the operation of the key apparatus, and an advantage of effectively reducing noise can be achieved.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A key apparatus, comprising:
a substrate;
a keycap;
a balancing lever, disposed between the substrate and the keycap, wherein the balancing lever comprises a shaft lever and a side lever extending from a side direction of the shaft lever, and the side lever has an end away from the shaft lever; and
a membrane layer, disposed on the substrate, wherein the membrane layer is provided with a cutting structure, the cutting structure is close to the end of the side lever, the membrane layer further comprises a flexible limiting area located on one side of the cutting structure, and the side lever of the balancing lever is inserted in the cutting structure, and makes the end be held against the flexible limiting area.

2. The key apparatus according to claim 1, wherein the flexible limiting area of the membrane layer is a long strip.

3. The key apparatus according to claim 2, wherein the long strip is perpendicular to the shaft lever, the end of the side lever is a hook, and the hook is hooked in the flexible limiting area.

4. The key apparatus according to claim 2, wherein the long strip is perpendicular to the side lever, and the end of the side lever is inserted in the cutting structure and is held against the flexible limiting area.

5. The key apparatus according to claim 1, wherein the cutting structure is a kerf.

6. The key apparatus according to claim 1, wherein the membrane layer comprises two holding areas that are separately adjacent to two ends of the flexible limiting area, and the key apparatus further comprises a fixing member to fix the two holding areas correspondingly.

7. The key apparatus according to claim 6, wherein the fixing member comprises an adhesive layer adhered between each holding area and the substrate.

8. The key apparatus according to claim 6, wherein the fixing member is fixed on the membrane layer and held against the two holding areas.

9. The key apparatus according to claim 1, wherein the membrane layer comprises a bearing area, and a bottom of the end of the side lever is further held against the bearing area.

10. The key apparatus according to claim 1, wherein the membrane layer is a membrane circuit board.

11. The key apparatus according to claim 10, wherein the membrane circuit board comprises an upper membrane layer, a spacer layer, and a lower membrane layer, the spacer layer is sandwiched between the upper membrane layer and the lower membrane layer, the lower membrane layer is farther away from the keycap than the upper membrane layer is, and the cutting structure at least penetrates the upper membrane layer.

12. The key apparatus according to claim 11, wherein the cutting structure penetrates the upper membrane layer and the spacer layer, and the bottom of the end of the side lever is borne on the lower membrane layer.

13. The key apparatus according to claim 11, wherein the cutting structure penetrates the upper membrane layer, and the bottom of the end of the side lever is borne on the spacer layer.

14. The key apparatus according to claim 1, wherein the flexible limiting area comprises a lower surface for contact with the side lever, and the lower surface is provided with an anti-slip structure.

15. The key apparatus according to claim 14, wherein the anti-slip structure comprises a cutting groove disposed on the lower surface.
